(19) United States
(12) Patent Application Publication
(10) Pub. No.: US 2017/0289043 A1
(43) Pub. Date: Oct. 5, 2017

(54) SYSTEMS AND METHODS FOR PERFORMING TRAFFIC ENGINEERING IN A COMMUNICATIONS NETWORK

(71) Applicant: Huawei Technologies Canada Co., Ltd., Kanata (CA)

(72) Inventors: Nan Zhang, Beijing (CN); Wei-Cheng Liao, Sunnyvale, CA (US); Mingyi Hong, Ankeny, IA (US); Hamidreza Farmanbar, Ottawa (CA); Zhi-Quan Luo, Maple Grove, MN (US)

(21) Appl. No.: 15/138,973

(22) Filed: Apr. 26, 2016

Related U.S. Application Data
(63) Continuation of application No. PCT/IB2016/051777, filed on Mar. 29, 2016.

(51) Int. Cl. H04L 12/803

(52) U.S. Cl. CPC H04L 47/125

(57) ABSTRACT

A method is disclosed for performing traffic engineering for a flow traversing a communications network having a plurality of nodes communicatively coupled by a plurality of links, with at least one of the plurality of links being a wireless link. The method includes setting an activation factor for the at least one wireless link in accordance with buffer statuses associated with nodes traversed by the flow; and transmitting the activation factor to a scheduling entity for scheduling activation of the at least one wireless link in accordance with the activation factor.

This application is a continuation of PCT Application No. PCT/IB/2016051777, entitled “Systems and Method for Performing Traffic Engineering in a Communications Network,” filed on Mar. 29, 2016, which application is hereby incorporated herein by reference.

### TECHNICAL FIELD

The present invention pertains to the field of network communications, and in particular towards systems and methods for performing traffic engineering in a communications network.

### BACKGROUND

Traffic Engineering (TE) is a technique that involves the analysis of flows over a network to help determine the routing and regulation of data transmissions over the network to improve network performance. Effective TE implementation can improve network resource allocation, reduce network congestion, and improve the quality of service (QoS) associated with the delivery of data across the network.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a system and method for performing traffic engineering over a communications network.

In accordance with embodiments of the present invention, there is provided a method for performing traffic engineering for a flow traversing a communications network, communications network including a plurality of nodes communicatively coupled by a plurality of links, at least one of the plurality of links being a wireless link. The method comprising: setting an activation factor for the at least one wireless link in accordance with buffer statuses associated with nodes traversed by the flow; and transmitting the activation factor to a scheduling entity for scheduling activation of the at least one wireless link in accordance with the activation factor.

In certain embodiments, the activation factor may be set in accordance with buffer statuses associated with a single node traversed by the flow.

In certain embodiments, the method further comprises setting a flow rate at the at least one wireless link traversed by the flow in accordance with the buffer statuses associated with the nodes traversed by the flow.

In certain embodiments, the method further comprises setting a net flow rate for the flow in accordance with the buffer statuses associated with the nodes traversed by the flow.

In certain embodiments, the activation factor for the at least one wireless link is determined according to a traffic engineering problem having at least one constraint comprising the buffer statuses associated with the nodes traversed by the flow. The constraints may also include: a link capacity constraint, an individual buffer bound constraint, a network flow conservation constraint, a half-duplex constraint, a general interference graph constraint, a buffer overflow constraint, and an achieved flow rate for commodity constraint. The traffic engineering problem may have a constraint comprising the activation factor for the at least one wireless link, wherein the activation factor is relaxed from a Boolean number to a real number. The traffic engineering problem may also comprise a utility function, which may be solved according to a mathematical programming method.

In accordance with embodiments of the present invention, there is provided a method for performing scheduling for a flow traversing a communications network having a plurality of nodes communicatively coupled by a plurality of links, at least one of the plurality of links being a wireless link. The method comprising: receiving an activation factor, associated with the at least one wireless link, indicative of a suggested amount of time within a defined time window that the at least one wireless link should be active; and scheduling activation of the at least one wireless link in accordance with the activation factor and one or more buffer statuses associated with nodes at either end of the at least one wireless link.

In certain embodiments, the step of scheduling activation of the at least one wireless link is performed in accordance with an edge-coloring method using the one or more buffer statuses.

In accordance with embodiments of the present invention, there is provided a Traffic Engineering (TE) controller comprising: a processor; an input interface coupled to the processor, the input interface for receiving buffer statuses associated with nodes traversed by a flow in a communications network; a memory coupled to the processor and having instructions stored therein, that when executed by the processor causes the TE controller to set an activation factor for at least one wireless link of the communications network in accordance with the buffer statuses; and an output interface coupled to the processor, the output interface for transmitting the activation factor for the at least one wireless link to a scheduler for scheduling activation of the at least one wireless link in accordance with the activation factor.

In accordance with embodiments of the present invention, there is provided a scheduler for scheduling activation of links for a flow traversing a communications network. The scheduler comprising: a processor; an input interface coupled to the processor, the input interface for receiving an activation factor for at least one wireless link of the communications network indicative of a suggested amount of time within a defined time window that the at least one wireless link should be active, and buffer statuses associated with nodes traversed by the flow in the communications network; a memory coupled to the processor and having instructions stored therein that when executed by the processor causes the scheduler to set scheduling of the at least one wireless link according to the activation factor and the buffer statuses associated with the nodes traversed by the flow; and an output interface coupled to the processor, the output interface for transmitting signals to activate the at least one wireless link in accordance with the set scheduling.

### BRIEF DESCRIPTION OF THE DRAWINGS

Further features and advantages of the present invention will become apparent from the following detailed description, taken in combination with the appended drawings, in which:

FIG. 1 illustrates a communications network, according to an embodiment;

FIG. 2 illustrates a communications network having a traffic engineering controller, and a link scheduler, according to an embodiment of the present invention;

FIG. 3A is a flow chart illustrating a method for performing traffic engineering for a communications network, according to an embodiment of the present invention;

FIG. 3B is a flow chart illustrating a method for performing scheduling for a flow traversing a communications network, according to an embodiment of the present invention;

FIG. 4 is a multi-graph illustrating an example of a distributed edge-coloring method accounting for buffer usage statistics, according to an embodiment of the present invention; and

FIG. 5 is a schematic diagram of a hardware device, according to an embodiment of the present invention.

It will be noted that throughout the appended drawings, like features are identified by like reference numerals.

### DETAILED DESCRIPTION OF ILLUSTRATIVE EMBODIMENTS

As used herein, a “network” or “communication network” comprises a plurality of nodes that are communicatively coupled by a plurality of links in order to transmit data therebetween, and serve the needs of various devices coupled to the network. The links may be wired or wireless. The devices may include wireless devices and user equipment (UE's). The nodes may be physical (e.g. access points, routers, base stations, eNodeB's, gateways etc. . . . ) or include virtualized components as will be readily apparent to a person skilled in the art.

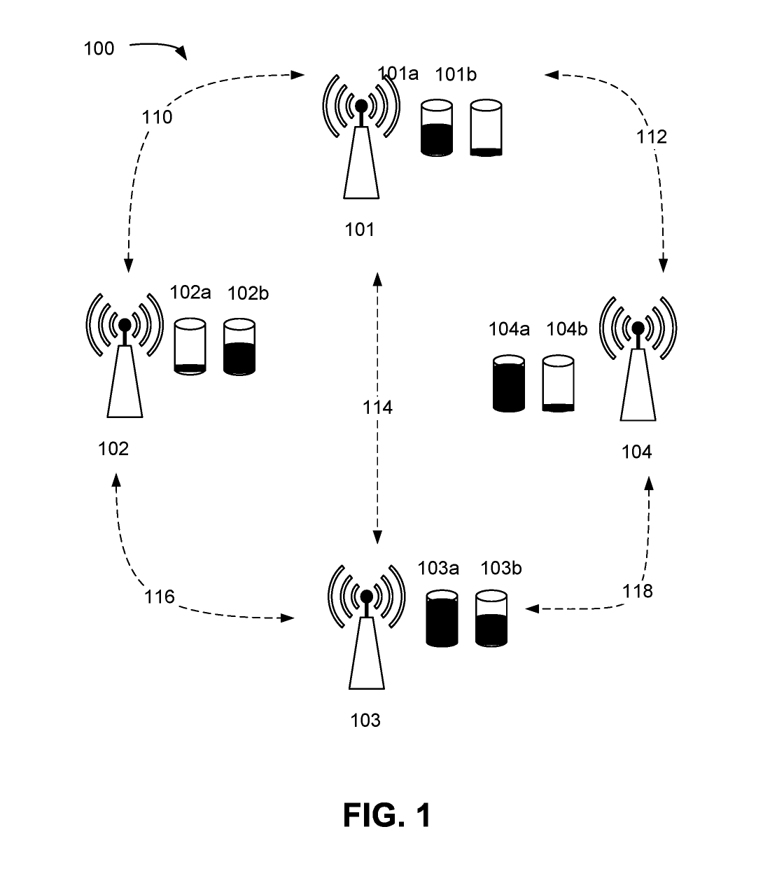

Referring to FIG. 1, there is shown a communications network 100 according to an embodiment. The communications network 100 includes a first source node 101, a second source node 102, a first destination node 103 and a second destination node 104, communicatively inter-coupled via wireless links 110, 112, 114, 116, 118, as shown. As understood by those skilled in the art, a flow is defined as the transmission of a commodity (e.g. data set) between a specific source-destination node pair. As shown in FIG. 1, flows for two commodities A and B are to be transmitted over network 100, including a first flow F_{A} for transmitting commodity A from the first source node 101 to the first destination node 103 (denoted as F_{A}(101, 103)), and a second flow F_{B} for transmitting commodity B from the second source node 102 to the second destination node (denoted as F_{B}(102, 104)). Each flow F_{A}, F_{B} includes the respective routes for delivering the commodity between their associated source and destination nodes. For example, first flow F_{A} includes three routes: R_{A-1} (via link 114), R_{A-2} (via link 110, node 102, and link 116), and R_{A-3} (via link 112, node 103, and link 118). Second flow F_{B} includes two routes: R_{B-1} (via link 110, node 101, and link 112), and R_{B-2} (via link 116, node 103, and link 118). Accordingly, the transmission of the commodity for each flow may be carried out through one or more of the associated routes therein.

Still referring to FIG. 1, each node 101, 102, 103, and 104 has further associated thereto buffers reserved for each commodity (A, B) when transmitted over the network 100. The buffers may act to store the entire commodity, or portions of the commodity, as they are being transmitted along respective routes of each flow. This is particularly relevant in the context of wireless half-duplex links, for example, as some links may become busy or congested, requiring the temporary storage of the commodity at a node until the link becomes available at a later time. For example, the first source node 101 includes buffers 101a, 101b reserved for the storage of commodities A, and B, respectively. Similarly, the second source node 102 includes buffers 102a, 102b, the first destination node 103 includes buffers 103a, 103b, and the second destination node 104 includes buffers 104a, 104b, all reserved for the storage of commodities A, and B, respectively.

Unfortunately, as each buffer is size-limited, the transmission of a commodity to a respective node having a buffer that is near or at capacity may cause a buffer overload, and result in packet loss, re-transmission requests, or other network delays and inefficiencies. For example, suppose for flow F_{A}(101,103), commodity A is to be transmitted from node 101 to node 104; since buffer 104a of node 104 (which is reserved for commodity A) is near capacity, any additional data relating to commodity A transmitted to node 104 may cause a buffer overflow in buffer 104a and become lost. Accordingly, an aspect of the present invention is to provide a traffic engineering system and method that at least partially mitigates or prevents the occurrence of buffer overloading from the transmission of flows over a communications network, in order to improve network operating efficiency.

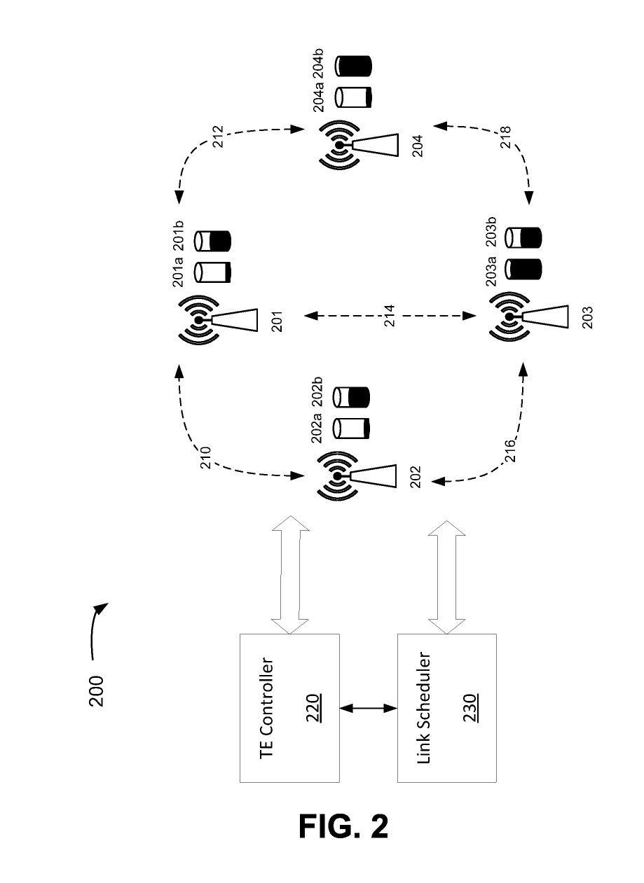

Referring to FIG. 2, there is shown a communications network 200 according to an embodiment of the present invention. The communications network 200 includes a first node 201, a second node 202, a third node 203, and a fourth node 204. Each of the nodes 201, 202, 203, 204 is communicatively coupled via wireless links 210, 212, 214, 216, and 218 as shown, for transmitting commodities (i.e. data) therebetween. Nodes 201, 202, 203, 204 further include buffers for the storage of respective commodities as they are transmitted along flows across the network 200. Specifically, node 201 includes buffers 201a and 201b, node 202 includes buffers 202a and 202b, node 203 includes buffers 203a and 203b, and node 204 includes buffers 204a and 204b, each reserved for the storage of commodities A and B, respectively.

The communications network 200 further includes a Traffic Engineering (TE) controller 220 that is communicatively coupled to a Link Scheduler 230 (which may also be referred to as a “Scheduler” or “Scheduling Entity”), wherein each of the TE controller 220 and Link Scheduler 230 are further communicatively coupled to nodes 201, 202, 203, and 204 (not specifically shown).

In operation, the TE controller 220 receives information regarding various flows to be performed on the communications network 200 (including that of links 210, 212, 214, 216, 218 that are traversed by the flows) and nodes 201, 202, 203, 204 (including the buffer status of buffers 201a, 201b, 202a, 202b, 203a, 203b, 204a, 204b, respectively) and provides one or more parameters to the Link Scheduler 230. The Link Scheduler 230 utilizes these parameters along with buffer status information (of buffers 201a, 201b, 202a, 202b, 203a, 203b, 204a, 204b), in order to schedule activation of links 210, 212, 214, 216, 218 along one or more routes of each flow, in a way that transmits commodities through the network 200 while reducing or mitigating the possibility of buffer overload in buffers 201a, 201b, 202a, 202b, 203a, 203b, 204a, and 204b of communications network 200. Accordingly, the TE controller 220 and Link Scheduler 230 may co-operatively act to transmit commodities through the network 200 in a way that improves resource allocation and reduces network congestion, while at the same time reducing or mitigating the possibility of buffer overload in various buffers.

In one embodiment, the TE controller 220 receives flow information relating to a flow, and buffer status information associated with at least one of nodes 201, 202, 203, 204, traversed by the flow, and determines an activation factor for at least one of wireless links 210, 212, 214, 216, 218. The activation factor represents a proportion of time relative to the long-term operational period of the communications network 200, which the corresponding wireless link should be activated. Put another way, it can be considered a percentage or suggested amount of time within a “time window” which a corresponding link should be active to enable transmissions. The Link Scheduler 230 receives the activation factor from the TE controller 220 for the at least one wireless link, and the buffer status information associated with nodes at either end of the at least one wireless link, and proceeds to schedule activation of the at least one wireless link 210, 212, 214, 216, 218 for one or more selected routes from the flow in order to transmit a commodity associated with the flow from its source node to its destination node. In this way, the scheduling of links 210, 212, 214, 216, 218 further accounts for the buffer status associated with nodes at either end of the link, in order to reduce or mitigate the occurrence of buffer overload at these nodes. For example, if the Link Scheduler 230 intends to schedule link 210, it would also consider one or more buffer statuses 201a, 201b, 202a, 202b of the nodes 201, 202, at either end of wireless link 210, respectively.

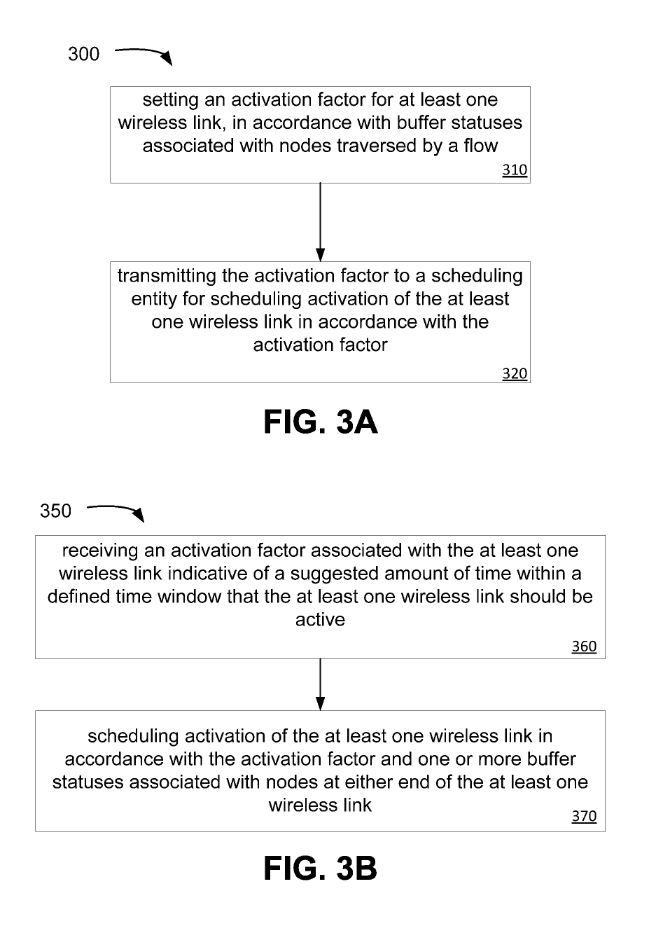

Referring to FIG. 3A, there is shown a flow chart illustrating a method 300 for performing traffic engineering for a flow traversing a communications network, according to an embodiment. The method 300 for example, may be carried out by the TE controller 220 over the communications network 200 of FIG. 2. At step 310, an activation factor is set for at least one wireless link of the communications network, in accordance with buffer statuses associated with nodes traversed by the flow. For example, if the flow does not traverse a certain wireless link in the communications network, its activation factor may be “0” as it does not need to be activated. Conversely, if the communications network comprises a single wireless link which the flow traverses, its activation factor may be “1”. In certain embodiments, for example if the flow only traverses a single node, the TE controller 220 may only set the activation factor in accordance with buffer status(es) associated with that single node. At step 320, the activation factor is transmitted to a scheduling entity (for example, Link scheduler 230 of FIG. 2) for scheduling activation of the at least one wireless link according to its corresponding activation factor.

In certain embodiments, the method 300 further comprises determining additional parameter(s) in accordance with the buffer status(es) associated with the nodes traversed by the flow, to improve traffic engineering across the network by regulating the transmission of commodities along certain links, or regulating certain flows. For example, a flow rate on one or more links traversed by the flow (including the at least one wireless link) may be set in accordance with the buffer statuses associated with the nodes traversed by the flow. This may for example be used to determine the flow rate at a source node of a flow, or determine traffic splitting at various intervening nodes of the flow. Additionally, a net flow rate for the flow may be set in accordance with the buffer statuses associated with the nodes traversed by the flow.

In certain embodiments, the activation factor for the at least one wireless link (i.e. step 310 of method 300) may be determined according to a traffic engineering problem having at least one constraint comprising buffer statuses associated with the nodes traversed by the flow. The traffic engineering problem may also comprise a plurality of different constraints, each for regulating and/or improving a behavioral aspect of flows across the communications network, as understood by persons skilled in the art. An example of a traffic engineering problem P is shown below:

$$( P ) {max}_{x , f , l} U ( {r}_{1} , {r}_{2} , … , {r}_{M} ) \qquad ( 1 )$$

where U(r₁, r₂, . . . , rₘ) is a utility function, such as a sum rate, minimum rate, weighted sum rate, load balancing, or proportional fairness, for commodities [1 . . . m] based on their received rate rₘ, x is the activation factor (i.e. activity indicator) on a link over an operational period, f is a flow rate on a link for a given commodity, and I is the net flow rate of a flow. A number of possible constraints that the traffic engineering problem may include are shown in Table 1 below, for example:

TABLE 1
List of traffic engineering constraints

| Constraint | Mathematical representation |
|---|---|
| Link capacity | Σₘfᵢⱼ^{m} ≦ xᵢⱼCᵢⱼ |
| | f^{m}ᵢⱼ is the flow rate on link (i, j) for commodity m |
| | xᵢⱼ is the activation factor (activity indicator) on link |
| | (i, j) (normally a Boolean number {0, 1} |
| | Cᵢⱼ is the upper bound link capacity on link (i, j) |
| Individual | 0 ≦ zᵢ^{m,1} ≦ z̅, i ≠ S(m), D(m) |
| buffer bound | _{zi}^{m,0} is the buffer size at node i before one long-term |
| | period |
| | _{zi}^{m,1} is the buffer size at node i after one long-term |
| | period |
| | z̅ is the finite buffer upper bound |
| | S(m) is the source node of m |
| | D(m) is the destination node of m |
| Network Flow | For i ≠ S(m): zᵢ^{m,0} + τ Σⱼfⱼᵢ^{m} = zᵢ^{m,1} + τ Σⱼfᵢⱼ^{m} |
| conservation | For i = S(m): τIₘ + zᵢ^{m,0} + τ Σⱼfⱼᵢ^{m} = zᵢ^{m,1} + τ Σⱼfᵢⱼ^{m} |
| | Iₘ is the net input rate for commodity m |
| | τ = duration of one long-term period/duration of |
| | short-term period |
| General | Σ_{l∈N}_{ᵢⱼ} xₗ ≦ 1, ∀ (i, j) |
| Interference | Nᵢⱼ is the set of neighbor links to link (i, j) on a conflict |
| Graph | graph (i.e. neighbor links cannot be simultaneously |
| | activated due to interference issues) |
| Half-Duplex | Σ_{i∈In(j)} xᵢⱼ + Σ_{k∈Out(j)} xⱼₖ ≦ 1, ∀ j |
| | This is a form/subset of a general interference graph |
| | constraint above, in that a link cannot transmit in both |
| | directions simultaneously |
| Buffer | τ fᵢⱼ^{m} ≦ xᵢⱼ z̅ |
| overflow | Prevents flows on a link from exceeding the buffer |
| | size at a receiving node |
| Achieved flow rate for commodity m | ${r}_{m} = \frac{1}{τ} ( {z}_{D ( m )}^{m , 1} - {z}_{D ( m )}^{m , 0} )$ Z_{D (m)} is the amount of bits stored in the buffer at destination node D(m) of commodity m, Z_{D}^{m,0} is the amount of data stored in the buffer before a long term period, and Z_{D}^{m,1} is the amount of data stored in the buffer after a long term period |

Some of the above constraints may be applicable in the case of wireless links, for example when the capacity of each link of the communications network is no longer fixed due to wireless channel conditions, inter-node interference, and half-duplex restrictions due to limited bandwidth and number of transceivers. Accordingly, in one embodiment, the traffic engineering problem P for a wireless communications network may appear as:

$$( P ) {max}_{x , f , l} U ( {r}_{1} , {r}_{2} , … , {r}_{M} ) \\ {f}_{ij}^{m} \geq 0 , {I}_{m} \geq 0 , {x}_{ij} ∈ [ 0 , 1 ] , ∀ m , ( i , j ) \qquad ( 2 )$$

while subject to the link capacity constraint, individual buffer bound constraint, network flow conservation constraint, general interference graph constraint, and achieved flow rate for commodity m constraint in Table 1 above. Other embodiments (not shown) may comprise additional or other situation specific constraints as understood by persons skilled in the art.

In certain embodiments, the activation factor on a link xᵢⱼ in one or more constraints of Table 1 may be relaxed from comprising a Boolean number ({0,1}) to a real number representing the proportion of time the link is active over an operational period. This may assist in solving the traffic engineering problem P in certain situations. The traffic engineering problem P may be solved by any suitable mathematical programming method, such as a linear programming method, including that of a distributed asynchronous alternating direction method of multipliers (ADMM) that solves a corresponding augmented Lagrangian function. In some embodiments, depending on the utility function selected (for example, when proportional fairness is used), the traffic engineering problem P may be solved according to a general convex programming method.

In certain embodiments, the buffer overflow constraint in Table 1 above may be substituted by an adaptively updated buffer overflow constraint as follows:

τfᵢⱼ^{m}≦xᵢⱼz̅ᵢ^{m} (3)

where
z̅ᵢ^{m}: variable capacity
z̅ᵢ^{m}≧θᵤz̅ [symbol] z̅ᵢ^{m}=max{z̅ᵢ^{m}−α, 0}
z̅ᵢ^{m}≦θᵢz̅ [symbol] z̅ᵢ^{m}=min{z̅ᵢ^{m}+α, z̅}
θₗ, θᵤ are chosen thresholds, α is predetermined constant

For further clarification, by replacing Z̅ with z̅ᵢ^{m} in the buffer overflow constraint, wherein Z̅ is the fixed finite buffer capacity at a node, and z̅ᵢ^{m} is a variable buffer capacity at node i, changes in the buffer capacities associated with various nodes may be accounted for (for example, at the end of a long-term operational period for the TE controller). Variable buffer capacities may be updated, and then used to determine activation factors on various links, in a subsequent operational period. θₗ and θᵤ are thresholds that may be optimized by trial and error through a given set of parameters. Consideration of a variable buffer capacity z̅ᵢ^{m} reflects the limitation on a link's capacity due to current buffer occupancy at the receiving node. In turn, the flow rate fᵢⱼ can be adjusted accordingly according to equation (3) above to mitigate potential buffer overflow. In certain embodiments, the traffic engineering problem may be solved for a relatively long-term (operational) period. Additionally, the step of scheduling activation of links may be performed over a relatively short-term (operational) period. For example, the long-term period may be in the order of seconds, and the short-term period in the order of milliseconds. In one embodiment, the long-term period equals τ short-term periods. When applied, for example, to the TE controller 220 and Link Scheduler 230 of FIG. 2, the TE controller 220 may solve the traffic engineering problem over a long-term operational period to deduce activation factors on each link, and possibly flow rates on each link and a net flow rate for each flow. These parameters can then be provided to the Link Scheduler 230, which proceeds to schedule activation of links during a short-term period. Advantageously, a two timescale approach allows the Link Scheduler 230 to perform its operations at a higher frequency than the TE controller 220, which may be additionally tasked with collaborating with other network nodes, or other functions.

Referring to FIG. 3B, there is shown a flow chart illustrating a method 350 for performing scheduling for a flow traversing a communications network, according to an embodiment. The method 350 for example, may be carried out by Link Scheduler 230 over the communications network 200 of FIG. 2. At step 360, an activation factor is received for at least one wireless link of the communications network. As understood from above, the activation factor may be indicative of a suggested amount of time within a defined time window that the at least one wireless link should be active. For example the “time window” may correspond to a long-term operational period of the TE controller 220 or communications network 200, and the suggested amount of time may be a percentage or fraction of the long-term operational period. As discussed above in method 300, the activation factor may also be determined according to buffer statuses associated with nodes traversed by the flow. At step 370, activation of the at least one wireless link is scheduled according to the activation factor and one or more buffer statuses associated with nodes at either end of the at least one wireless link.

In certain embodiments, the step of scheduling activation of the at least one wireless link (i.e. step 370 of method 350) may be performed in accordance with an edge coloring method that accounts for buffer usage statistics (for example, from one or more buffer status(es) associated with nodes at either end of the at least wireless link, or nodes traversed by the flow). As understood by persons skilled in the art, edge coloring is a technique that has application in many engineering problems including link scheduling. Edge coloring involves the assignment of colors to edges in a multi-graph such that two edges having the same color are not incident on the same node; this may then be formulated into scheduling activation of links in a communications network. Unfortunately, the use of standard edge-coloring alone may incorporate an improper visiting sequence of nodes, and fail to consider buffer statistics, resulting in inefficient or wasted link activation opportunities.

The following pseudo code illustrates an embodiment of edge-coloring using the buffer status associated with nodes of a communications network:

| | |
|---|---|
| 1. | Construct [symbol] |
| 2. | For each short-term period |
| | If [symbol] = , break; |
| | Else |
| | Calculate Bᵢ |
| | Visit the nodes in decreasing order of Bᵢ; |
| | For each node choose one incident edge to color |
| | Active the colored edges and update the buffer status; |
| | Delete the colored edges from the [symbol] ; |
| | End |
| | End |

In step 1 of the above pseudo code, [symbol] is a multi-graph representing a communications network, which can be expressed as (υ,ε), where υ is the set of nodes in the network, and ε is the set of edges. The edges for the multi-graph [symbol] may be chosen according to:

$${n}_{ij} = ⌊ \frac{τ}{2} {x}_{ij}^{*} ⌋ , ∀ ( i , j ) \text{:} {l}_{ij} ∈ ℒ . \qquad ( 4 )$$

where nᵢⱼ are the number of edges for link lᵢⱼ between node i and j, x*ᵢⱼ is the corresponding solution obtained from the traffic engineering problem P in equation (2) above. The above constraint for any given link lᵢⱼ represents that for it to be activated with activation factor x*ᵢⱼ, nᵢⱼ different colors should be applied for each edge.

In step 2, the short-term period can be represented as a long-term period divided by τ above (e.g. Short-term period=Long-term period/τ) according to the operational period of the communications network. Further, Bᵢ represents the maximum data size that can be transmitted by node vᵢ in one short period given by:

$${B}_{i} = {\sum }_{m = 1}^{M} {b}_{i}^{m} , \\ {b}_{i}^{m} = \{ \begin{matrix}min \{ \overline{z} , {z}_{i}^{m} \} , & if i = S ( m ) , \\ {z}_{i}^{m} , & otherwise .\end{matrix} \qquad ( 5 )$$

Accordingly, if vᵢ is not the source node for any commodity m, then Bᵢ is the exactly the total size of data in vᵢ. To realize link flows fᵢⱼ for example, provided by TE Controller 220), the link activation/scheduling may give priority to nodes which can contribute more to network throughput. This can be done by visiting nodes in decreasing order of Bᵢ in each short-term period, giving nodes with relatively and potentially larger data transmission sizes higher scheduling priority. When a node vᵢ is visited, the sub-step of “choose one incident edge color” may be performed according to the following strategy: while satisfying interference constraints, if there are incident edges corresponding to outgoing links, choose the one whose destination node has the smallest Bⱼ; otherwise, choose the edge whose source node has the largest Bⱼ.

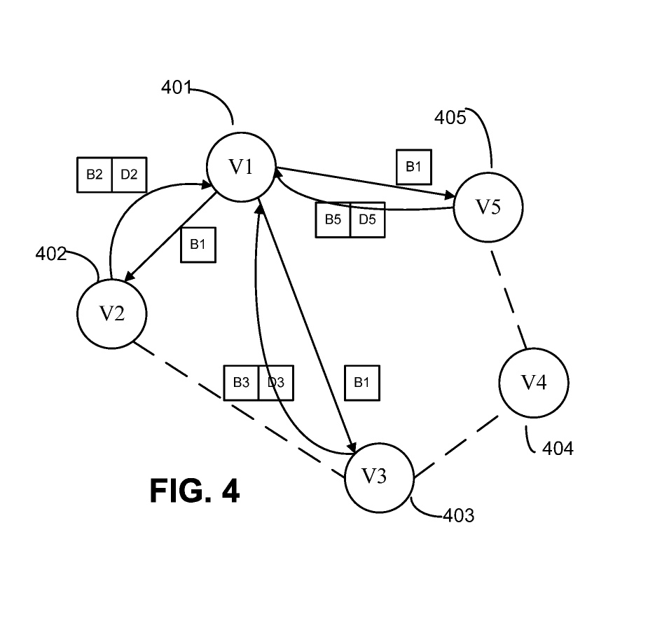

In some embodiments, an edge coloring method that accounts for buffer usage statistics can be implemented in a distributed manner, which reduces or mitigates the need to visiting nodes one-by-one. Referring to FIG. 4, there is shown a multi-graph of a communications network 400 comprising node v₁ 401, node v₂ 402, node v₃ 403, node v₄ 404, node v₅ 405, which illustrates an example of a distributed edge-coloring method accounting for buffer usage statistics, according to an embodiment. Here, we assume that each node v₁ can only communicate with its neighbors (i.e., the set of nodes Aᵢ:={vⱼ|ₗᵢⱼε [symbol] or ₗⱼᵢ ε [symbol] }. For each node vᵢ, it exchanges its buffer status {zᵢ^{m}}ₘ and its decision (the incident edge to be colored) with all the neighbor nodes in Ai. After receiving the decisions of all neighbors who have a higher Bj, the node v₁ makes a decision by choosing available incident edges to color while satisfying hardware constraints. For example, if there are incident edges corresponding to outgoing links, vᵢ may choose the one whose destination node has the smallest Bⱼ; otherwise, vᵢ may choose the edge whose source node has the largest Bⱼ. FIG. 4 illustrates an example of a node v₁ communicating with its neighbors v₂, v₃, and v₅. Since B₃,B₅≧B₁ and B₂<B₁, vᵢ waits until receiving the decisions D₃ and D₅, then makes its own decision to choose feasible incident edges.

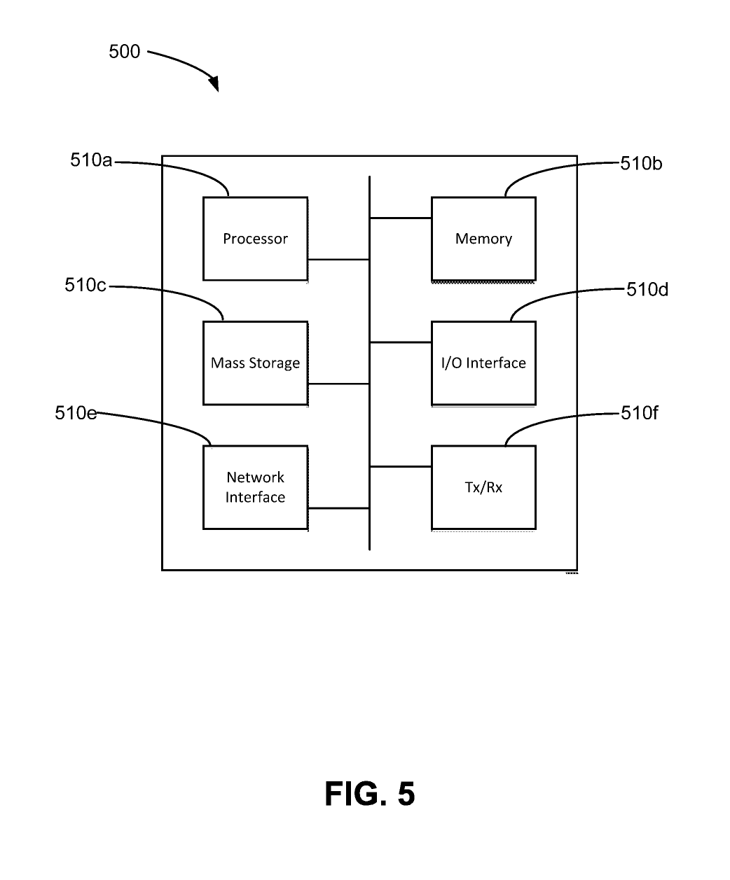

FIG. 5 is schematic diagram of a hardware device 500 that may comprise for example, the TE controller 230 or Link Scheduler 230 shown in FIG. 2, according to embodiments of the present invention. As shown, the hardware device 500 includes a processor 510a, memory 510b, non-transitory mass storage 510c, I/O interface 510d, network interface 510e, and a transceiver 510f, all of which are communicatively coupled via bi-directional bus. According to certain embodiments, any or all of the depicted elements may be utilized, or only a subset of the elements. Further, the hardware device 500 may contain multiple instances of certain elements, such as multiple processors, memories, or transceivers. Also, elements of the hardware device may be directly coupled to other elements without the bi-directional bus.

The memory 510b may include any type of non-transitory memory such as static random access memory (SRAM), dynamic random access memory (DRAM), synchronous DRAM (SDRAM), read-only memory (ROM), any combination of such, or the like. The mass storage element 510c may include any type of non-transitory storage device, such as a solid state drive, hard disk drive, a magnetic disk drive, an optical disk drive, USB drive, or any computer program product configured to store data and machine executable program code. According to certain embodiments, the memory 510b or mass storage 510c may have recorded thereon statements and instructions executable by the processor 510a for performing the aforementioned functions of the TE controller 230 and/or Link Scheduler 230 of FIG. 2, or the method 300 of FIG. 3.

Embodiments of the present invention disclose a communications network having a TE controller and a Link Scheduler, which are communicatively coupled to nodes of the communication network in order to manage the transmission of commodities associated with various flows through the network. The TE controller may operate on a long-term timescale, and provides an activation factor for each link traversed by a flow according to one or more buffer statuses associated with nodes traversed by the flow. The Link Scheduler may operate on a short-term timescale, and schedules the activation of links to elicit transmission of respective commodities associated with flows, according to the activation factor for each link provided by the TE controller, and one or more buffer statuses associated with nodes traversed by the flow. The TE controller and the Link Scheduler cooperatively work together to carry out traffic engineering operations over the communications network, in an effort to improve resource allocation and transmission efficiency across various links, while also reducing or mitigating the incidence of buffer overflow associated with nodes of the communications network, which can lead to data loss or re-transmission requests.

Unless defined otherwise, all technical and scientific terms used herein have the same meaning as commonly understood by one of ordinary skill in the art to which this invention belongs.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for performing traffic engineering for a flow traversing a communications network, the communications network having a plurality of nodes communicatively coupled by a plurality of links, at least one of the plurality of links being a wireless link, the method comprising:
setting an activation factor for the at least one wireless link, in accordance with buffer statuses associated with nodes traversed by the flow; and
transmitting the activation factor to a scheduling entity for scheduling activation of the at least one wireless link in accordance with the activation factor.

2. The method of claim 1 further comprising setting a flow rate on the at least one wireless link traversed by the flow in accordance with the buffer statuses associated with the nodes traversed by the flow.

3. The method of claim 1 further comprising setting a net flow rate for the flow in accordance with the buffer statuses associated with the nodes traversed by the flow.

4. The method of claim 1 wherein the activation factor for the at least one wireless link is determined according to a traffic engineering problem having at least one constraint comprising the buffer statuses associated with the nodes traversed by the flow.

5. The method of claim 4 wherein the traffic engineering problem comprises a plurality of constraints selected from the group consisting of: link capacity constraint, individual buffer bound constraint, network flow conservation constraint, half-duplex constraint, general interference graph constraint, buffer overflow constraint, an achieved flow rate for commodity constraint, and combinations thereof.

6. The method of claim 4 wherein the traffic engineering problem has at least one constraint comprising the activation factor for the at least one wireless link, wherein the activation factor is relaxed from a Boolean number to a real number.

7. The method of claim 5 wherein the buffer overflow constraint comprises an adaptively updated buffer overflow constraint.

8. The method of claim 4 wherein the traffic engineering problem is solved according to a mathematical programming method.

9. The method of claim 4 wherein the traffic engineering problem comprises a utility function.

10. The method of claim 9 wherein the utility function is selected from the group consisting of sum rate, minimum rate, weighted sum rate, load balancing, and proportional fairness.

11. The method of claim 4 wherein the traffic engineering problem is solved for a long-term operational period, and the activation factor for the at least one wireless link comprises a fraction of the long-term operational period.

12. A method for performing scheduling for a flow traversing a communications network having a plurality of nodes communicatively coupled by a plurality of links, at least one of the plurality of links being a wireless link, the method comprising:
receiving an activation factor, associated with the at least one wireless link, indicative of a suggested amount of time within a defined time window that the at least one wireless link should be active; and
scheduling activation of the at least one wireless link in accordance with the activation factor and one or more buffer statuses associated with nodes at either end of the at least one wireless link.

13. The method of claim 12 wherein the step of scheduling activation of the at least one wireless link is performed in accordance with an edge-coloring method using the one or more buffer statuses.

14. The method claim 12 wherein the activation factor is determined for a long-term operational period, and the step of scheduling activation of the at least one wireless link is performed over a short-term operational period less than or equal to the long-term operational period.

15. A Traffic Engineering (TE) controller comprising:
a processor;
an input interface coupled to the processor, the input interface for receiving buffer statuses associated with nodes traversed by a flow in a communications network;
a memory coupled to the processor and having instructions stored therein, that when executed by the processor causes the TE controller to set an activation factor for at least one wireless link of the communications network in accordance with the buffer statuses; and
an output interface coupled to the processor, the output interface for transmitting the activation factor for the at least one wireless link to a scheduler for scheduling activation of the at least one wireless link in accordance with the activation factor.

16. The TE controller of claim 15 wherein the memory contains further instructions stored therein, which when executed by the processor causes the TE controller to set a flow rate on the at least one wireless link traversed by the flow in accordance with the buffer statuses, and the output interface is further for providing the flow rate to the communications network.

17. The TE controller of claim 15 wherein the memory contains further instructions stored therein, which when executed by the processor causes the TE controller to determine a net flow rate for the flow in the communications network in accordance with the buffer statuses, and the output interface is further for providing the net flow rate to the communications network.

18. The TE controller of claim 15 wherein the activation factor for the at least one wireless link of the communications network is determined according to a traffic engineering problem having at least one constraint comprising the buffer statuses associated with the nodes traversed by the flow.

19. The TE controller of claim 18 wherein the traffic engineering problem comprises a plurality of constraints, wherein the constraints are selected from the group consisting of: link capacity constraint, individual buffer bound constraint, network flow conservation constraint, half-duplex constraint, general interference graph constraint, buffer overflow constraint, an achieved flow rate for commodity constraint, and combinations thereof.

20. The TE controller of claim 18 wherein the traffic engineering problem has at least one constraint comprising the activation factor for the at least one wireless link, wherein the activation factor is relaxed from a Boolean number to a real number.

21. The TE controller of claim 19 wherein the buffer overflow constraint comprises an adaptively updated buffer overflow constraint.

22. The TE controller of claim 18 wherein the traffic engineering problem is solved according to a mathematical programming method.

23. The TE controller of claim 18 wherein the traffic engineering problem comprises a utility function.

24. The TE controller of claim 23 wherein the utility function is selected from the group consisting of sum rate, minimum rate, weighted sum rate, load balancing, and proportional fairness.

25. The TE controller of claim 18 wherein the traffic engineering problem is solved for a long-term operational period, and the activation factor for each link comprises a fraction of the long-term operational period.

26. A scheduler for scheduling activation of links for a flow traversing a communications network, the scheduler comprising:
a processor;
an input interface coupled to the processor, the input interface for receiving an activation factor for at least one wireless link of the communications network indicative of a suggested amount of time within a defined time window that the at least one wireless link should be active, and buffer statuses associated with nodes traversed by the flow in the communications network;
a memory coupled to the processor and having instructions stored therein that when executed by the processor causes the scheduler to set scheduling of the at least one wireless link according to the activation factor and the buffer statuses associated with the nodes traversed by the flow; and
an output interface coupled to the processor, the output interface for transmitting signals to activate the at least one wireless link in accordance with the set scheduling.

27. The scheduler of claim 26 wherein the scheduling activation of the links is determined in accordance with an edge-coloring method using the buffer statuses associated with the nodes traversed by the flow.

28. The scheduler of claim 26 wherein the activation factor is determined for a long-term operational period, and determining scheduling of the at least one wireless link is performed over a short-term operational period less than or equal to the long-term operational period.

29. A computer readable memory having recorded thereon statements and instructions for execution by a computer for performing traffic engineering for a flow traversing a communications network, the communications network having a plurality of nodes communicatively coupled by a plurality of links, at least one of the plurality of links being a wireless link, the statements and instructions comprising:
setting an activation factor for the at least one wireless link in accordance with buffer statuses associated with nodes traversed by the flow; and
transmitting the activation factor to a scheduling entity for scheduling activation of the at least one wireless link in accordance with the activation factor.
